(19) United States
(12) Patent Application Publication
(10) Pub. No.: US 2017/0063451 A1
(43) Pub. Date: Mar. 2, 2017

(54) COMMUNICATION SYSTEM, COMMUNICATION APPARATUS, AND COMMUNICATION METHOD

(71) Applicant: FUJITSU LIMITED, Kawasaki-shi (JP)

(72) Inventors: Michio KURAMOTO, Meguro (JP); Yasuyuki Mitsumori, Kawasaki (JP)

(73) Assignee: FUJITSU LIMITED, Kawasaki-shi (JP)

(21) Appl. No.: 15/232,374

(22) Filed: Aug. 9, 2016

(30) Foreign Application Priority Data
Sep. 2, 2015 (JP) 2015-172592

(51) Int. Cl. H04B 10/079; H04Q 11/00; H04J 14/08

(52) U.S. Cl. CPC H04B 10/0795; H04J 14/08; H04Q 11/0005; H04Q 11/0062; H04Q 2011/0033; H04Q 2011/0083

(57) ABSTRACT

There is provided a communication apparatus including a hardware processor configured to: count numbers of transmissions and receptions of a measurement frame assigned between frames when a communication of an active system is performed, by an active system counter, count numbers of transmissions and receptions of the measurement frame when a communication of a standby system is performed, assign switchover indication information for indicating an occurrence of the switchover from the active system to the standby system, to the measurement frame to be transmitted to other communication apparatus, and measure a data loss based on a count value of the active system counter or the standby system counter, by excluding frames transferred during a period of time from a transmission of the switchover indication information to a reception of the reception indication information transmitted from the other communication apparatus which has received the switchover indication information, from a measurement target.

### CROSS-REFERENCE TO RELATED APPLICATION

This application is based upon and claims the benefit of priority from the prior Japanese Patent Application No. 2015-172592 filed on Sep. 2, 2015, the entire contents of which are incorporated herein by reference.

### FIELD

The embodiments discussed herein are related to a communication system, a communication apparatus, and a communication method.

### BACKGROUND

A time division multiplexing (TDM) based network, such as a synchronous optical network (SONET) or a synchronous digital hierarchy (SDH), is known as a carrier network. However, with the recent spread of the Internet or the mobile networks, the carrier network has switched from the TDM based network to a packet based network utilizing the Ethernet (trademark registered) technology or the Internet protocol (IP) technology.

There is a transfer scheme adopted for simultaneously transferring a frame to a plurality of destinations in the packet based network such as the IP network or the Ethernet. As for the scheme for simultaneously transferring a frame to a plurality of destinations, a broadcast transfer at the time of Ethernet frame flooding in a bridge device and a multicast transfer of an IP frame in a router device are known. The multicast transfer of an IP frame is used in, for example, a video distribution service or an Internet protocol-television (IP-TV) service.

The packet based network that adopts the scheme for simultaneously transferring a frame to a plurality of destinations is provided with a plurality of user terminals which are connected to communicate with each other through a plurality of communication apparatuses arranged in, for example, a mesh topology.

A communication apparatus includes an interface (IF) card which accommodates a line port and provides, for example, a function of interface with an external apparatus or a function of a reception frame processing and a transmission frame processing. The communication apparatus may be provided with a plurality of IF cards for network redundancy. When the communication apparatus is provided with the plurality of IF cards, some of the plurality of IF cards are used as active system IF cards, and the other is used as standby system IF cards. When a fault such as a failure occurs in an IF card of the active system, an intra-IF card switchover processing is performed such that an IF card of the standby system takes over the function of the IF card in which the fault has occurred.

It is known that an IF card measures a transmission count value and a reception count value according to the number of frames that are transmitted and received so as to conduct an Ethernet (trademark registered) frame loss measurement (ETH-LM).

Related techniques are disclosed in, for example, Japanese Laid-Open Patent Publication No. 2010-045760, Japanese National Publication of International Patent Application No. 2009-525013, and Japanese Laid-Open Patent Publication No. 10-303914.

Related techniques are disclosed in, for example, TELECOMMUNICATION STANDARDIZATION SECTOR OF ITU “Recommendation ITU-T G.8013/Y.1731,” November, 2013 in Non-Patent Literature.

### SUMMARY

According to an aspect of the invention, a communication system includes: a first communication apparatus capable of performing a switchover of a communication path from an active system to a standby system, and configured to include a first hardware processor configured to: count a number of transmissions and a number of receptions of a measurement frame assigned between frames transferred on the communication path when a communication of the active system is performed, by an active system counter, count the number of transmissions and the number of receptions of the measurement frame when a communication of the standby system is performed, by a standby system counter, measure a data loss based on a count value of the active system counter or the standby system counter, and assign switchover indication information for indicating an occurrence of the switchover from the active system to the standby system, to the measurement frame to be transmitted; and a second communication apparatus capable of performing a switchover of a communication path from an active system to a standby system, and configured to include a second hardware processor configured to assign reception indication information for indicating a reception of the switchover indication information, to a measurement frame to be transmitted to the first communication apparatus according to reception, from the first communication apparatus, of the measurement frame to which the switchover indication information is assigned, wherein the first hardware processor measures the data loss by excluding frames which are transferred during a period of time from a transmission of the switchover indication information to a reception of the reception indication information, from a measurement target.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating an exemplary configuration of a communication system of an embodiment of the present disclosure;

FIG. 2 is a diagram schematically illustrating an exemplary configuration of a communication apparatus of an embodiment of the present disclosure;

FIG. 3 is a diagram schematically illustrating an exemplary functional configuration of a communication apparatus of a transmission side of the embodiment;

FIG. 4 is a diagram schematically illustrating an exemplary functional configuration of a communication apparatus of a reception side of the embodiment;

FIG. 5A is a diagram illustrating an example of an Ethernet frame format without a VLAN tag in the communication system as an example of the embodiment, and FIG. 5B is a diagram illustrating an example of an Ethernet frame format with a VLAN tag in the communication system as an example of the embodiment;

FIG. 6 is a diagram illustrating an example of a lost measurement message protocol data unit (LMM PDU) format in the communication system as an example of the embodiment;

FIG. 7 is a diagram illustrating an example of a lost measurement response protocol data unit (LMR PDU) format in the communication system as an example of the embodiment;

FIG. 8 is a diagram illustrating a location in which a switchover bit for a packet loss frame is assigned in the communication system as an example of the embodiment;

FIG. 9 is a flowchart for illustrating a frame loss measurement process in a case where IF card switchover does not occur in the communication system as an example of the embodiment;

FIG. 10 is a flowchart for illustrating a frame loss measurement adjusting process in a case where the IF card switchover occurs in the communication system as an example of the embodiment;

FIG. 11 is another flowchart for illustrating the frame loss measurement adjusting process in a case where the IF card switchover occurs in the communication system as an example of the embodiment;

FIG. 12A is a timing chart illustrating transmission and reception timing of a packet loss frame in an active system IF card included in a communication apparatus, which is in a normal operation state, of the transmission side as an example of the embodiment, and FIG. 12B is a timing chart illustrating transmission and reception timing of a packet loss frame in a standby system IF card included in the communication apparatus;

FIG. 13A is a timing chart illustrating transmission and reception timing of a packet loss frame in the active system IF card included in the communication apparatus of the transmission side when a failure occurs as an example of the embodiment, and FIG. 13B is a timing chart illustrating transmission and reception timing of a packet loss frame in the standby system IF card included in the communication apparatus of the transmission side when a failure occurs as an example of the embodiment;

FIG. 14A is a timing chart illustrating transmission timing of a packet loss frame in the active system IF card included in the communication apparatus of the transmission side as an example of the embodiment after switchover of an IF card, and FIG. 14B is a timing chart illustrating transmission timing of a packet loss frame in the standby system IF card included in the communication apparatus of the transmission side after switchover of the IF card; and

FIG. 15A is a timing chart illustrating reception timing of a packet loss frame in the active system IF card included in the communication apparatus of the transmission side as an example of the embodiment after switchover of an IF card, and FIG. 15B is a timing chart illustrating reception timing of a packet loss frame included in the communication apparatus of the transmission side after switchover of the IF card.

### DESCRIPTION OF EMBODIMENTS

In a case where a frame loss measurement is conducted in a redundant configuration between IF cards, synchronization of transmission count values measured between the IF cards is not established immediately after switchover processing is conducted between the IF cards, and thus, an abnormal value of the transmission count values is likely to be notified to an operator.

Accordingly, it may be considered that a transmission count value measured by an IF card at which abnormality occurs is notified to a standby system IF card so as to establish synchronization of transmission count values between the IF cards.

However, in a case of establishing the synchronization of transmission count values between the IF cards, when the number of accommodated users such as the number of virtual local area network (VLAN) within a network is increased, a scale of a circuit required for synchronization or a load on software may also be increased.

Hereinafter, descriptions will be made on an embodiment of a technique capable of easily and correctly conducting data loss measurement even when redundancy switchover has occurred with reference to the accompanying drawings. However, the embodiment illustrated in the following is merely illustrative, and it is not intended to exclude the application of various modification or techniques thereto. That is, the embodiment may be variously changed without departing from the gist of the embodiment.

The respective drawings are not intended to include only the elements illustrated in the drawings, and may include, for example, other functions.

In the drawings, an identical reference numeral refers to an identical portion. Thus, hereinafter, overlapping descriptions of the identical reference numeral will be omitted.

### A Example of Embodiment

### A-1System Configuration

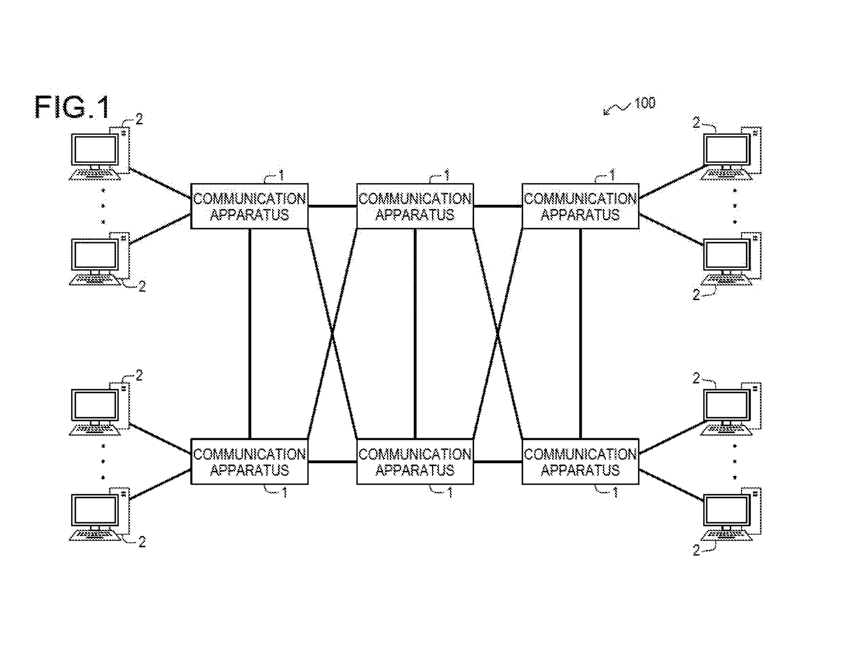

FIG. 1 is a diagram schematically illustrating an exemplary configuration of a communication system 100 of an embodiment.

The communication system 100 is provided with a plurality of communication apparatuses 1 (six communication apparatuses in the illustrated example) and a plurality of user terminals 2, as illustrated in FIG. 1. The number of the communication apparatuses 1 and the user terminals 2 which are provided in the communication system 100 may be variously changed. The respective user terminals 2 are connected to be communicable with each other through a single or a plurality of communication apparatuses 1 provided within a network.

The user terminal 2 is an information processing device provided with a central processing unit (CPU), a random access memory (RAM), a read only memory (ROM), or a hard disk drive (HDD).

The communication apparatus 1 performs a processing for receiving a frame transmitted from the user terminal 2 and transmitting the frame to a designated destination based on, for example, address information stored in the frame. For example, in a case where the user terminal 2 transmits an Ethernet frame, the communication apparatus 1 performs a frame transmission processing based on a media access control (MAC) address stored in the Ethernet frame. In a case where the user terminal 2 transmits an IP frame, the communication apparatus 1 performs a frame transmission processing based on an IP address stored in the IP frame.

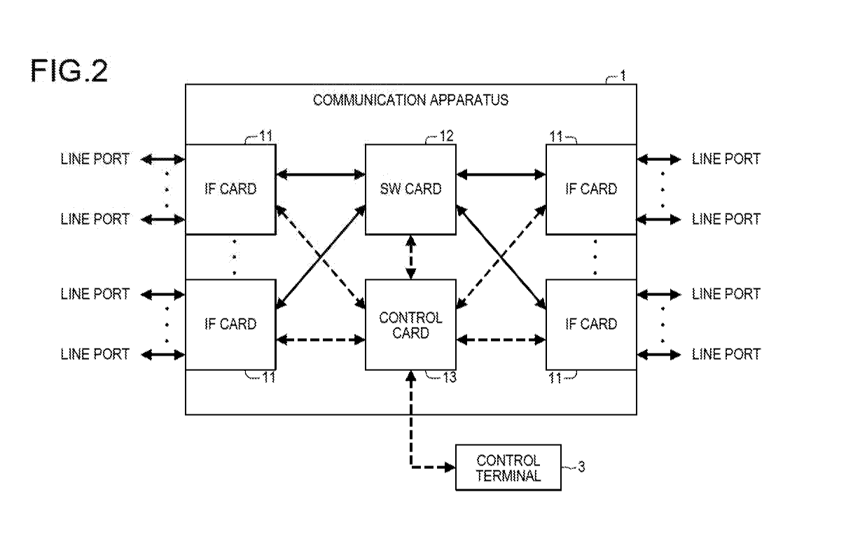

FIG. 2 is a diagram schematically illustrating an exemplary configuration of a communication apparatus 1 of an embodiment.

As illustrated in FIG. 2, the communication apparatus 1 is provided with a plurality of IF cards 11 (four IF cards in the illustrated example), a switch (SW) card 12, and a control card 13. In FIG. 2, a solid line bidirectional arrow indicates that a data signal is transmitted and received between two cards, and a dotted line bidirectional arrow indicates that a control signal is transmitted and received between two cards.

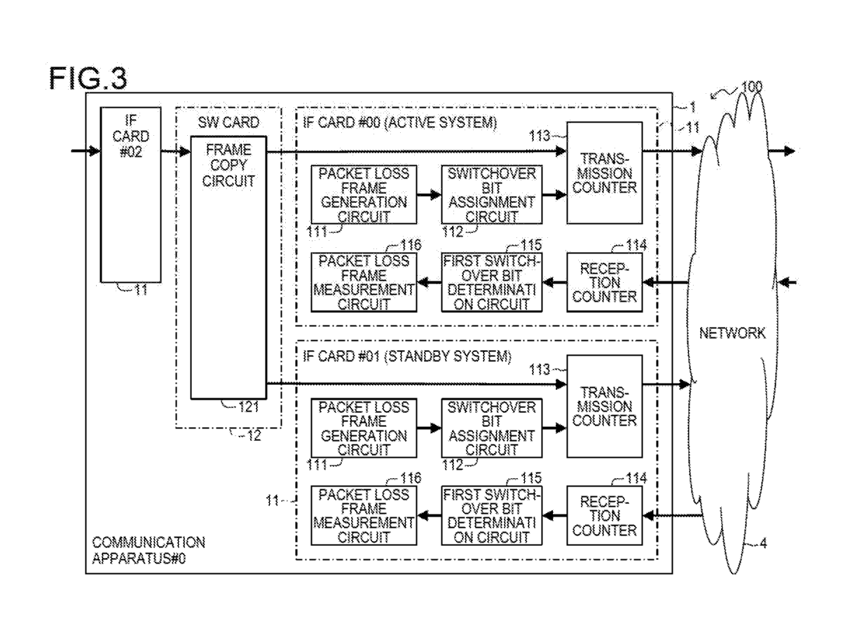

The SW card 12 is a circuit which transmits and receives the data signal with the IF card 11 and provides a switch function in a frame transmission between the IF cards 11. The SW card 12 is, for example, a module or a card detachable from the communication apparatus 1 and is provided with a frame copy circuit 121 which will be described later with reference to FIG. 3.

The control card 13 transmits and receives the control signal with the IF card 11 and the SW card 12, and performs, for example, various settings, collecting of alarm information, and collecting of statistical information for each card within the communication apparatus 1. The control card 13 is, for example, a module or a card detachable from the communication apparatus 1. The control card 13 is connected to be capable of transmitting and receiving the control signal with a control terminal 3 as illustrated in FIG. 2.

The control terminal 3 is a processing apparatus provided with a CPU, a RAM, a ROM, and an HDD which are not illustrated. The control terminal 3 functions as an external monitor through which a user monitors the state of the communication apparatus 1.

The IF card 11 is a circuit which accommodates a single line port or a plurality of line ports and provides an interface function (e.g., a reception frame processing function or a transmission frame processing function) for an external apparatus such as other communication apparatuses 1 or the user terminal 2. The IF card 11 is, for example, a module or a card detachable from the communication apparatus 1.

The IF card 11, the SW card 12, and the control card 13 may not be detachable from the communication apparatus 1 and may be integrally formed in a mother board (mother card), which is not illustrated, provided in the communication apparatus 1.

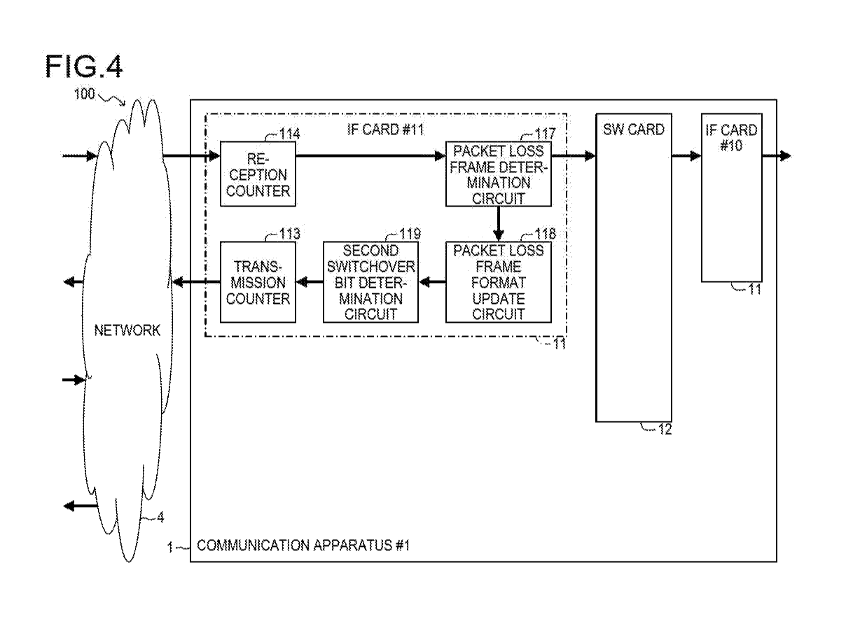

FIG. 3 is a diagram schematically illustrating an exemplary functional configuration of the communication apparatus 1 of a transmission side of the embodiment. FIG. 4 is a diagram schematically illustrating an exemplary functional configuration of the communication apparatus 1 of a reception side of the embodiment.

The communication apparatus 1 (communication apparatus #0) illustrated in FIG. 3 functions as a transmission side communication apparatus which transmits measurement data to the communication apparatus 1 (communication apparatus #1) illustrated in FIG. 4 and measures a frame loss occurring between the communication apparatus 1 (communication apparatus #0) and the communication apparatus 1 (communication apparatus #1). The communication apparatus 1 (communication apparatus #1) illustrated in FIG. 4 functions as a reception side communication apparatus which receives measurement data from the communication apparatus 1 (communication apparatus #0) illustrated in FIG. 3 and replies measurement data for a reply according to the received measurement data to the communication apparatus 1 (communication apparatus #0).

The “frame loss” may be referred to as “packet loss” or “data loss.” The “measurement data” may be referred to as a “measurement frame” or a “measurement packet.”

Here, the frame loss measurement in the example of the embodiment corresponds to, for example, the frame loss measurement by ETH-LM described in Chapter 8.1 of ITU-T Recommendations G.8013/Y.1731.

Hereinafter, when it is needed to specify one of a plurality of communication apparatuses, the communication apparatus is denoted by a “communication apparatus #0” or a “communication apparatus #1,” but an arbitrary communication apparatus is denoted by a “communication apparatus 1.”

11

The communication apparatus #0 is provided with IF cards #00 to #02 as the IF card 11. The communication apparatus #1 is provided with IF cards #10 and #11 as the IF card 11.

Hereinafter, when it is needed to specify one of a plurality of IF cards, the IF card is denoted by an “IF card #00,” “IF card #01,” “IF card #02,” “IF card #10,” or “IF card #11,” but an arbitrary IF card is denoted by an “IF card 11.”

In FIGS. 3 and 4, illustration of the control card 13 and some of the IF cards 11 provided in the communication apparatus 1 is omitted for convenience.

The SW card 12 of the communication apparatus #0 is provided with the frame copy circuit 121 as illustrated in FIG. 3. The SW card 12 of the communication apparatus #1 is also provided with the frame copy circuit 121, but illustration of the frame copy circuit 121 is omitted in FIG. 4 for convenience.

In a case where the data signal such as a frame is received from the IF card 11, the frame copy circuit 121 copies the received data signal and transfers the received data signal to other IF card 11. In the example illustrated in FIG. 3, the frame copy circuit 121 copies the data signal received from the IF card #02 and transfers the data signal to IF cards #00 and #01.

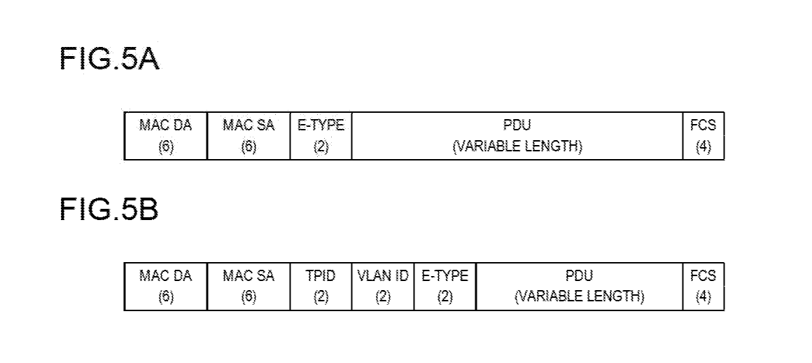

FIG. 5A is a diagram illustrating an example of an Ethernet frame format without a VLAN tag in the communication system 100 as an example of the embodiment, and FIG. 5B is a diagram illustrating an example of the Ethernet frame format with a VLAN tag.

The communication apparatus 1 (communication system 100) in the example of the embodiment transmits and receives the Ethernet frame having a format illustrated in FIGS. 5A and 5B as the data signal.

The Ethernet frame without a VLAN tag includes, for example, a media access control destination address (MAC DA), a media access control source address (MAC SA), an Ethernet type (E-TYPE), a protocol data unit (PDU), and a frame check sequence (FCS), as illustrated in FIG. 5A.

The MAC DA is, for example, a 6-byte destination MAC address.

The MAC SA is, for example, a 6-byte source MAC address.

The E-TYPE is, for example, 2 bytes and stores a type of a message to be stored in the PDU, which is the next field of the E-TYPE, in the frame. For example, the E-TYPE of “0x0800” indicates an Internet protocol version 4 (IPv4) frame. An allocation of the E-TYPE is performed by the Internet assigned numbers authority (TANA).

The PDU has, for example, a variable length and stores a message of an upper layer such as an IPv4 frame.

The FSC is, for example, 4 bytes, and corresponds to a cyclic redundancy check-32 (CRC-32) symbol for frame error detection. A VLAN ID value for specifying the user is stored in the FSC field.

The Ethernet frame with a VLAN tag includes, for example, the MAC DA, the MAC SA, a tag protocol identifier (TPID), a virtual local area network identifier (VLAN ID), the E-TYPE, the PDU, and the FCS, as illustrated in FIG. 5B.

The TPID is, for example, 2 bytes and a sort of the E-TYPE. The TPID is an ID indicating that the VLAN ID is stored in the next field of the TPID in the frame, and a value of “0x8100” stipulated in IEEE 802.1Q is set in the TPID.

The VLAN ID is, for example, 2 bytes and stores an identifier for specifying a user.

The TPID together with the VLAN ID is referred to as an LVAN tag. It becomes possible to continuously stack a plurality of VLANs by the VLAN tag.

The Ethernet frame format without a VLAN tag and the Ethernet frame format with a VLAN tag illustrated in FIGS. 5A and 5B, respectively, are the conventional Ethernet frame format, and thus, detailed description thereof will be omitted.

In the example illustrated in FIG. 3, the IF card #00 functions as an IF card of an active system, and the IF card #01 functions as an IF card of a standby system. That is, in a case where a fault such as a failure occurs within the IF card #00 or a communication path to which the IF card #00 is connected, the IF card #01 takes over the interface function of the IF card #00. The IF card #01 of the standby system may be in a hot standby state or a cold standby state before taking over the interface function of the IF card #00 of the active system.

As illustrated in FIGS. 3 and 4, the IF card 11 is provided with a packet loss frame generation circuit 111, a switchover bit assignment circuit 112, a transmission counter 113, a reception counter 114, a first switchover bit determination circuit 115, a packet loss frame measurement circuit 116, a packet loss frame determination circuit 117, a packet loss frame format update circuit 118, and a second switchover bit determination circuit 119.

In FIG. 3, functional constituents required for measuring frame loss as the transmission side communication apparatus #0 are illustrated in the IF cards #00 and #01, and illustration of some functional constituents is omitted. In FIG. 4, functional constituents required for causing the transmission side communication apparatus #0 to measure packet loss as the reception side communication apparatus #1 are illustrated in the IF card #10 and illustration of some functional constituents is omitted.

That is, the packet loss frame generation circuit 111, the switchover bit assignment circuit 112, the transmission counter 113, the reception counter 114, the first switchover bit determination circuit 115, and the packet loss frame measurement circuit 116 are illustrated in the IF cards #00 and #01 provided in the transmission side communication apparatus #0 of FIG. 3. Furthermore, the transmission counter 113, the reception counter 114, the packet loss frame determination circuit 117, the packet loss frame format update circuit 118, and the second switchover bit determination circuit 119 are illustrated in the IF card #10 provided in the reception side communication apparatus #1 of FIG. 4.

The functions as the packet loss frame generation circuit 111, the switchover bit assignment circuit 112, the transmission counter 113, the reception counter 114, the first switchover bit determination circuit 115, and the packet loss frame measurement circuit 116 of the transmission side communication apparatus #0 are executed by any one of the IF card #00 of the active system and the IF card #01 of the standby system. In a case where switchover of the IF card 11 does not occur in the communication apparatus #0, the functions as the packet loss frame generation circuit 111, the switchover bit assignment circuit 112, the transmission counter 113, the reception counter 114, the first switchover bit determination circuit 115, and the packet loss frame measurement circuit 116 are executed by the IF card #00 of the active system. In a case where switchover of the IF card 11 occurs in the communication apparatus #0, the functions as the packet loss frame generation circuit 111, the switchover bit assignment circuit 112, the transmission counter 113, the reception counter 114, the first switchover bit determination circuit 115, and the packet loss frame measurement circuit 116 are executed by the IF card #01 of the standby system.

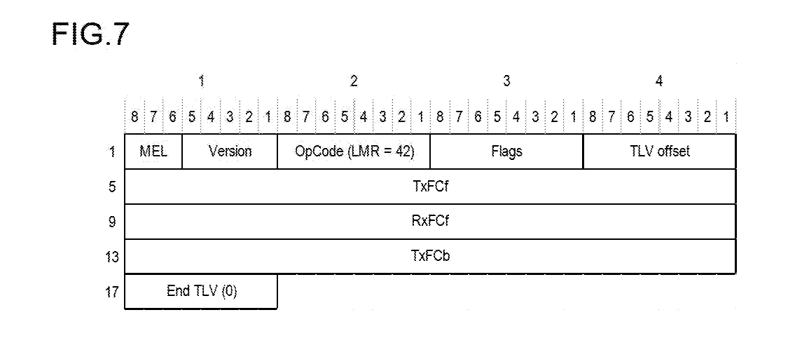

The packet loss frame generation circuit 111 illustrated in FIG. 3 generates an Ethernet-lost measurement message (ETH-LMM; hereinafter, simply referred to as the LMM) as measurement data for measuring data loss which occurs between the communication apparatuses #0 and #1. Hereinafter, the LMM together with an Ethernet-lost measurement response (ETH-LMR; hereinafter, simply referred to as the LMR), which will be described later with reference to FIG. 7, may be referred to as a packet loss frame.

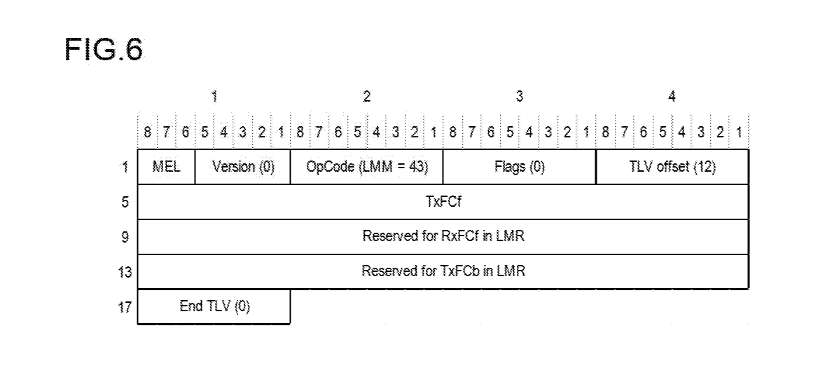

FIG. 6 is a diagram illustrating an example of LMM PDU format in the communication system 100 as an example of the embodiment.

The LMM PDU illustrated in FIG. 6 is stored in the PDU element of the Ethernet frame illustrated in FIGS. 5A and 5B. That is, the packet loss frame generation circuit 111 stores the LMM PDU illustrated in FIG. 6 in the PDU element of the Ethernet frame illustrated in FIGS. 5A and 5B to generate the LMM.

The LMM PDU format illustrated in FIG. 6 corresponds to the conventional PDU format, and thus, descriptions thereof will be omitted.

The switchover bit assignment circuit 112 illustrated in FIG. 3 assigns a switchover bit, which indicates an occurrence of switchover, to the LMM to be transmitted to the communication apparatus #1 according to the switchover of the IF card 11. In other words, the switchover bit assignment circuit 112 assigns a switchover bit, which indicates an occurrence of a switchover from a communication path of an active system to a communication path of a standby system, to a measurement frame to be transmitted to the communication apparatus #1.

Specifically, the switchover bit assignment circuit 112 detects an interrupt occurring according to the switchover from the IF card #00 of the active system to the IF card #01 of the standby system. The interrupt is issued by, for example, the IF card #00 of the active system or the control card 13 (see FIG. 2). When the interrupt is detected, the switchover bit assignment circuit 112 assigns the switchover bit to the LMM generated by the packet loss frame generation circuit 111. In addition, when the interrupt is detected, the switchover bit assignment circuit 112 may initialize a count value of the transmission counter 113 provided in the same IF card 11. Meanwhile, when the interrupt is not detected, the switchover bit assignment circuit 112 does not assign the switchover bit to the LMM generated by the packet loss frame generation circuit 111.

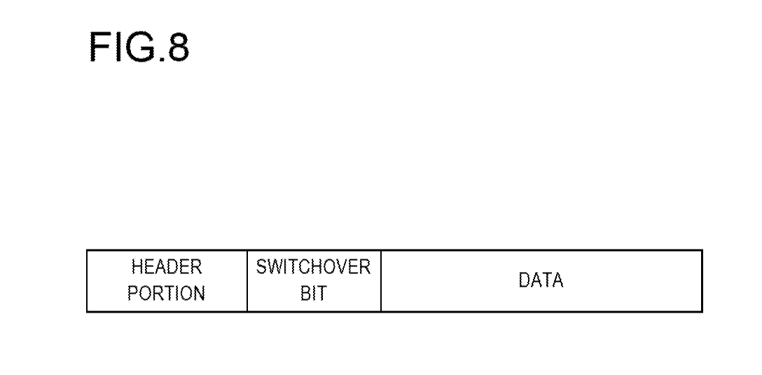

Details of the switchover bit will be described later with reference to FIG. 8.

The transmission counter 113 illustrated in FIGS. 3 and 4 counts the user data or the number of transmissions of the packet loss frames (transmission count value) to be transmitted to other communication apparatus 1. The transmission count value counted by the transmission counter 113 is stored in the packet loss frame to be transmitted to other communication apparatus 1. The packet loss frame in which the transmission count value is stored by the transmission counter 113 is sent out to a network 4 such as a wide local area network (LAN).

The reception counter 114 illustrated in FIGS. 3 and 4 counts the user data or the number of receptions of the packet loss frames (reception count value) received from other communication apparatus 1. The reception count value counted by the reception counter 114 is stored in the packet loss frame received from other communication apparatus 1.

The transmission counter 113 and the reception counter 114 counts the number of transmissions and receptions of the packet loss frames for other communication apparatus 1. The transmission counter 113 and the reception counter 114 of the IF card #00 of the active system count the number of transmissions and receptions of measurement frames at the time of communication using the communication path of the active system. The transmission counter 113 and the reception counter 114 of the IF card #01 of the standby system count the number of transmissions and receptions of measurement frames at the time of communication using the communication path of the standby system. The measurement frame is inserted, for example, between frames to be transferred over the communication path and is assigned the number of frames to be transferred over the communication path.

The first switchover bit determination circuit 115 illustrated in FIG. 3 controls the data loss measurement by the packet loss frame measurement circuit 116 based on the switchover bit assigned to the LMR received from the communication apparatus #1. In other words, the first switchover bit determination circuit 115 excludes frames, which are transferred during a period of time from transmission of the switchover bit to reception of the switchover bit from the communication apparatus # 1, from the data loss measurement targets by the packet loss frame measurement circuit 116.

Specifically, the first switchover bit determination circuit 115 determines whether the LMM to which the switchover bit is assigned is transmitted to the communication apparatus #1, and the switchover bit is assigned to the LMM received from the communication apparatus #1.

In a case where the LMM to which the switchover bit is assigned is not transmitted to the communication apparatus #1, the first switchover bit determination circuit 115 does not stop the data loss measurement by the packet loss frame measurement circuit 116.

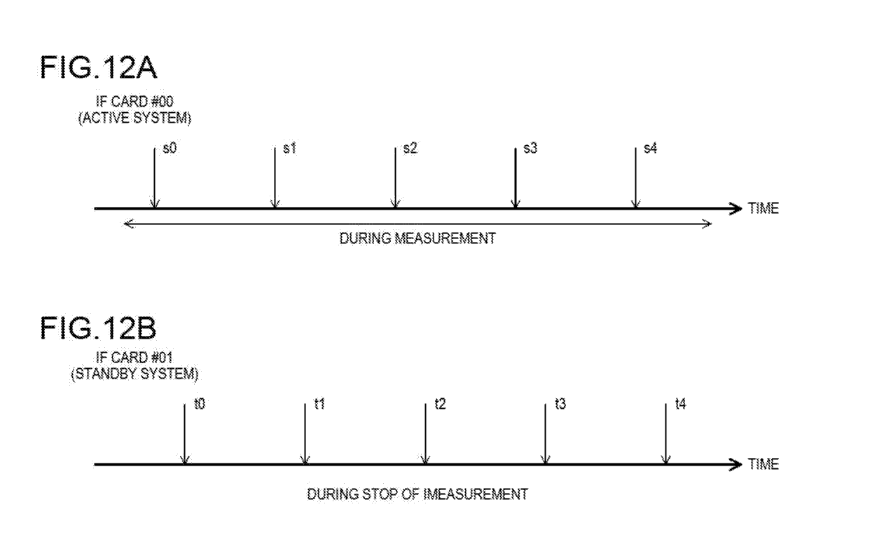

In a case where the LMM to which the switchover bit is assigned is transmitted to the communication apparatus #1, and the switchover bit is not assigned to the LMM received from the communication apparatus #1, the first switchover bit determination circuit 115 stops the data loss measurement by the packet loss frame measurement circuit 116 for a predetermined period of time. Here, the predetermined period of time corresponds to a period of time from transmission of the LMM, to which the switchover bit is assigned, to the communication apparatus #1 to reception of the LMM to which the switchover bit is assigned from the communication apparatus #1. Furthermore, details of the period of time, during which the frame loss measurement is stopped by the first switchover bit determination circuit 116, will be describe later with reference to FIGS. 12A to 15B.

In a case where the LMM to which the switchover bit is assigned is transmitted to the communication apparatus #1, and the switchover bit is assigned to the LMM received from the communication apparatus #1, the first switchover bit determination circuit 115 allows the frame loss measurement by the packet loss frame measurement circuit 116 to be restarted. In a case where the switchover bit is assigned to the received LMM, the first switchover bit determination circuit 115 may initialize the count value of the reception counter 114 provided in the same IF card 11.

The packet loss frame measurement circuit 116 illustrated in FIG. 3 measures data loss occurring between the communication apparatuses #0 and #1 based on a count value of the transmission counter 113 and a count value of the reception counter 114.

For example, in a case where the count value of the transmission counter 113 coincides with the count value of the reception counter 114 provided in the same IF card 11, the packet loss frame measurement circuit 116 determines that frame loss has not occurred between the communication apparatuses #0 and #1. In a case where the count value of the transmission counter 113 does not coincide with the count value of the reception counter 114 provided in the same IF card 11, the packet loss frame measurement circuit 116 determines that packet loss occurs between the communication apparatuses #0 and #1.

The packet loss frame measurement circuit 116 performs the frame loss measurement based on the following Equation (1) for measuring the frame loss at the far-end (communication apparatus #1 side) and the frame loss measurement based on the following Equation (2) for measuring the frame loss at the near-end (communication apparatus #0 side)

Frame Loss (far-end)=|TxFCf[tc]−TxFCf[tp]|−|RxFCf[tc]−RxFCf[tp]| Equation (1)

Frame Loss (near-end)=|TxFCb[tc]−TxFCb[tp]|−|RxFCl[tc]−RxFCl[tp]| Equation (2)

Here, the “TxFCf” is a transmission count value to be stored in the LMM at the time of transmitting the LMM, and the “RxFCf” is a reception count value to be stored in the LMM at the time of receiving the LMM. The “TxFCb” is a transmission count value to be stored in the LMR at the time of transmitting the LMM, and the “RxFCl” is a reception count value to be stored in the LMR at the time of receiving the LMM. The “tc” indicates the (current) transmission count value or the (current) reception count value after switchover of the IF card 11, and the “tp” indicates the (previous) transmission count value or the (previous) reception count value before the switchover of the IF card.

The packet loss frame determination circuit 117 illustrated in FIG. 4 determines whether data received from the communication apparatus #0 is a packet loss frame (LMM). When it is determined that the received data is, for example, user data other than the LMM, the packet loss frame determination circuit 117 transmits the received data to the SW card 12. When it is determined that the received data is the LMM, the packet loss frame determination circuit 117 transmits the received data to the packet loss frame format update circuit 118.

The packet loss frame format update circuit 118 updates a format of the packet loss frame received from the communication apparatus #0.

Specifically, the packet loss frame format update circuit 118 extracts, for example, the transmission count value and the reception count value and stored in the LMM which is received from the communication apparatus #0. The packet loss frame format update circuit 118 updates the data of the LMM frame so as to generate an LMR which is a packet loss frame for replying to the communication apparatus #0 by the communication apparatus #1.

FIG. 7 is a diagram illustrating an example of a lost measurement response protocol data unit (LMR PDU) format in the communication system 100 as an example of the embodiment.

The LMR PDU illustrated in FIG. 7 is stored in a PDU element of the Ethernet frame illustrated in FIGS. 5A and 5B. That is, the packet loss frame format update circuit 118 stores the LMR PDU illustrated in FIG. 7 in the PDU element of the Ethernet frame illustrated in FIGS. 5A and 5B to generate the LMR.

Since the LMR PDU format is the conventional PDU format, descriptions thereof will be omitted.

The second switchover bit determination circuit 119 illustrated in FIG. 4 assigns the switchover bit to LMR according to the reception of the LMM, to which the switchover bit is assigned, from the communication apparatus #0. In other words, the second switchover bit determination circuit 119 assigns the switchover bit, which indicates reception of the switchover bit, to a measurement frame to be transmitted to the communication apparatus #0 according to the reception of the LMM to which the switchover bit is assigned.

Specifically, the second switchover bit determination circuit 119 determines whether the switchover bit is assigned to the LMM received from the communication apparatus #0. When it is determined that the switchover bit is assigned to the received LMM, the second switchover bit determination circuit 119 assigns the switchover bit with respect to the LMR of which format is updated by the packet loss frame format update circuit 118. When it is determined that the switchover bit is not assigned to the received LMM, the second switchover bit determination circuit 119 does not assign the switchover bit with respect to the LMR of which format is updated by the packet loss frame format update circuit 118.

FIG. 8 is a diagram illustrating a location in which a switchover bit with respect to a packet loss frame is assigned in the communication system 100 as an example of the embodiment.

The switchover bit is an example of 1 bit switchover indication information which is assigned to the LMM to be transmitted to the reception side communication apparatus #1 by the transmission side communication apparatus #0 and indicates occurrence of switchover from the IF card #00 of the active system to the IF card #01 of the standby system. The switchover bit is an example of 1 bit reception indication information which is assigned to the LMR to be replied to the transmission side communication apparatus #0 from the reception side communication apparatus #1 and indicates reception of the switchover indication information by the reception side communication apparatus #1.

The switchover bit is assigned between, for example, a header portion and a data in the LMM and the LMR as illustrated in FIG. 8.

The switchover bit may be assigned to an area for Flags in the LMM and the LMR illustrated in FIGS. 6 and 7, respectively. In general, an empty bit field is prepared in the area for Flags of the LMM and the LMR, and thus, the switchover bit may be easily inserted.

The switchover bit may be assigned to an area prepared by extending a space between a TLV offset area and an End TLV area in the LMM and the LMR, illustrated in FIGS. 6 and 7, respectively.

The switchover bit may be assigned within a Version area in the LMM and the LMR illustrated in FIGS. 6 and 7, respectively. When a value of the Version area, which is set to, for example, “0” in an initial state, is set to“1,” it is recognized that the switchover bit is assigned therein. In general, a write bit for extension is prepared in the Version area of the LMM and the LMR, and thus, the switchover bit may be easily inserted.

The switchover bit may be assigned in such a way that a number (separate type value, unused number), which is not reserved conforming to a standard, is set to a field for a type or a length of the Ethernet frame. For example, a separate type value may be assigned to the E-TYPE area illustrated in FIGS. 5A and 5B, and the switchover bit may be assigned to an area of any one of the LMM and the LMR illustrated in FIGS. 6 and 7, respectively.

The functions as the packet loss frame generation circuit 111, the switchover bit assignment circuit 112, the transmission counter 113, the reception counter 114, the first switchover bit determination circuit 115, the packet loss frame measurement circuit 116, the packet loss frame determination circuit 117, the packet loss frame format update circuit 118, and the second switchover bit determination unit 119 illustrated in FIGS. 3 and 4 are implemented by a hardware processor (not illustrated) provided in the IF card 11.

The hardware processor (not illustrated) provided in the IF card 11 controls the IF card 11 in its entirety. The hardware processor may be a multiprocessor. The hardware processor is, for example, any one of a CPU, a micro processing unit (MPU), a digital signal processor (DSP), an application specific integrated circuit (ASIC), a programmable logic device (PLD), and a field programmable gate array (FPGA). Furthermore, the hardware processor may be a combination of two or more of the CPU, the MPU, the DSP, the ASIC, the PLD, and the FPGA.

### A-2 Operation

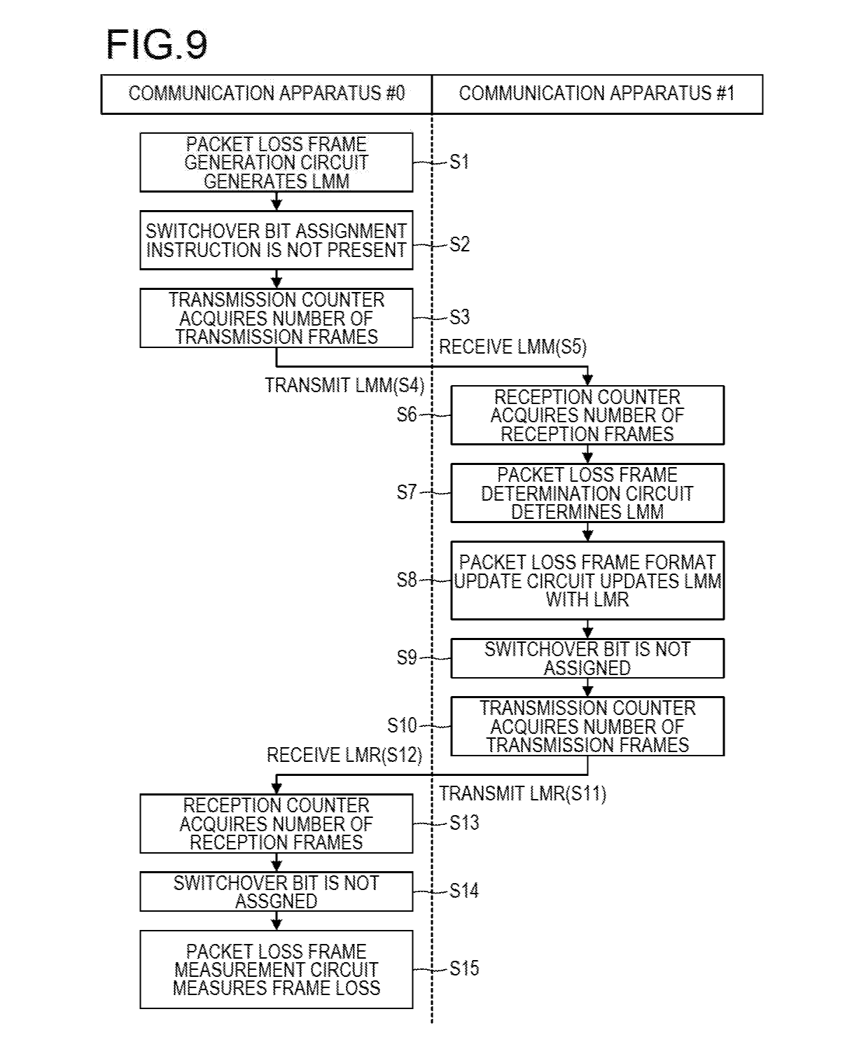

Descriptions will be made on a frame loss measurement process for a case where switchover of the IF card 11 does not occur in the communication system 100, which is configured as described above, as an example of the embodiment. Descriptions will be made in line with the flowchart (Operations S1 to S15) illustrated in FIG. 9.

Processings of Operations S1 to S4 and S12 to S15 illustrated in FIG. 9 are executed by the IF card #00 of the active system provided in the communication apparatus #0 illustrated in FIG. 3, and processings of Operations S5 to S11 illustrated in FIG. 9 are executed by the IF card #10 provided in the communication apparatus #1 illustrated in FIG. 4.

The packet loss frame generation circuit 111 of the communication apparatus #0 generates the LMM (Operation S1 in FIG. 9).

The switchover bit assignment circuit 112 of the communication apparatus #0 determines whether a switchover bit assignment instruction (interrupt) due to the switchover of the IF card 11 has issued. In the example illustrated in FIG. 9, the switchover bit assignment circuit 112 determines that the switchover bit assignment instruction has not issued and does not assign the switchover bit to the LMM (Operation S2 in FIG. 9).

The transmission counter 113 of the communication apparatus #0 increments the transmission count value (the number of transmission frames) according to the transmission of the LMM to acquire the transmission count value (the number of transmission frames) (Operation S3 in FIG. 9).

The communication apparatus #0 transmits the LMM to the communication apparatus #1 (Operation S4 in FIG. 9).

The communication apparatus #1 receives the LMM from the communication apparatus #0 (Operation S5 in FIG. 9).

The reception counter 114 of the communication apparatus #1 increments the reception count value (the number of reception frames) according to the reception of the LMM to acquire the reception count value (Operation S6 in FIG. 9).

The packet loss frame determination circuit 117 of the communication apparatus #1 determines whether the data received from the communication apparatus #0 is the LMM (Operation S7 in FIG. 9). In the example illustrated in FIG. 9, it is assumed that the received data are the LMM.

The packet loss frame format update circuit 118 of the communication apparatus #1 updates the LMM received from the communication apparatus #0 with the LMR (Operation S8 in FIG. 9).

The second switchover bit determination circuit 119 of the communication apparatus #1 determines whether a switchover bit is assigned to the LMM received from the communication apparatus #0. In the example illustrated in FIG. 9, the second switchover bit determination circuit 119 determines that the switchover bit is not assigned to the received LMM and does not assign the switchover bit to the LMR (Operation S9 in FIG. 9).

The transmission counter 113 of the communication apparatus #1 increments the transmission count value (the number of transmission frames) according to the transmission (reply) of the LMR to acquire the number of transmission frames (Operation S10 in FIG. 9).

The communication apparatus #1 transmits (replies) the LMR to the communication apparatus #0 (Operation S11 in FIG. 9).

The communication apparatus #0 receives the LMR from the communication apparatus #1 (Operation S12 in FIG. 9).

The reception counter 114 of the communication apparatus #0 increments the reception count value (the number of reception frames) according to the reception of the LMR to acquire the number of reception frames (Operation S13 in FIG. 9).

The first switchover bit determination circuit 115 of the communication apparatus #0 determines whether the switchover bit is assigned to the LMM which is transmitted to the communication apparatus #1, and the switchover bit is assigned to the LMR received from the communication apparatus #1. In the example illustrated in FIG. 9, the first switchover bit determination circuit 115 determines that the switchover bit is not assigned to the transmitted LMM, the switchover bit is not assigned to the received LMR, and does not suppress the frame loss measurement (Operation S14 in FIG. 9).

The packet loss frame measurement circuit 116 measures the frame loss that has occurred between the communication apparatuses #0 and #1 (Operation S15 in FIG. 9). Specifically, the packet loss frame measurement circuit 116 determines whether the number of transmission frames acquired at Operation S3 in FIG. 9 coincides with the number of reception frames acquired at Operation S13 in FIG. 9. With this, the packet loss frame measurement circuit 116 measures the frame loss occurring between the communication apparatuses #0 and #1. Then, the frame loss measurement process is ended.

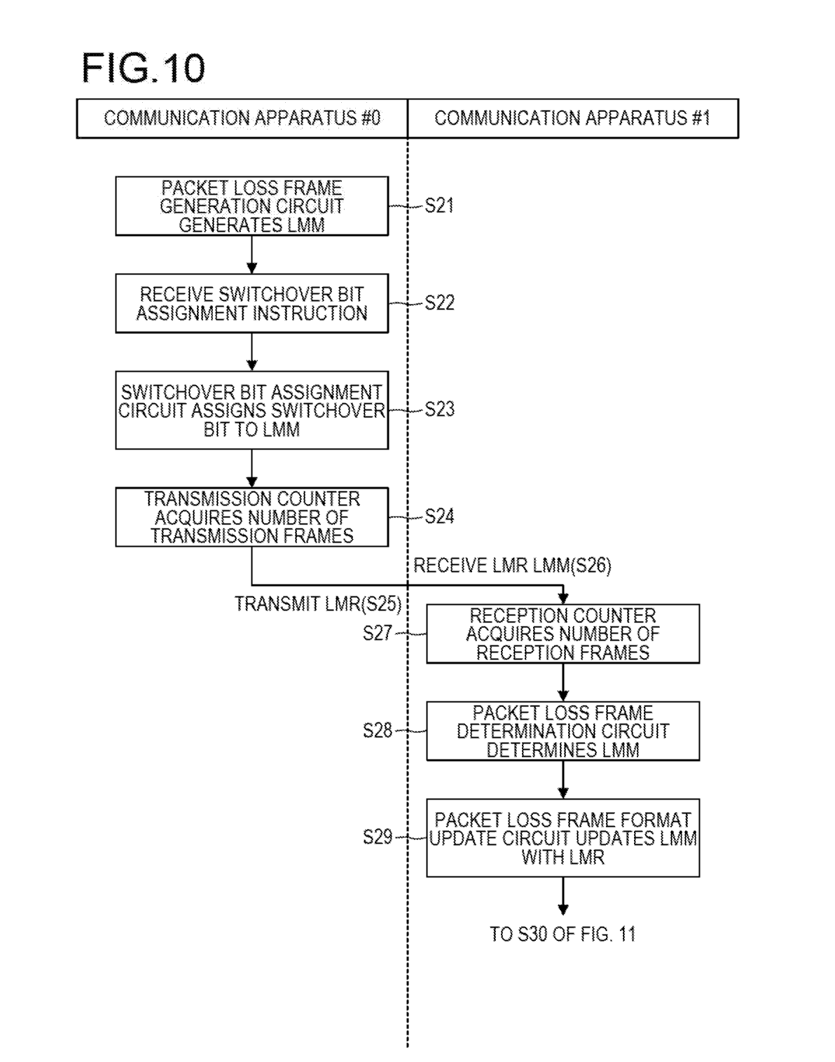

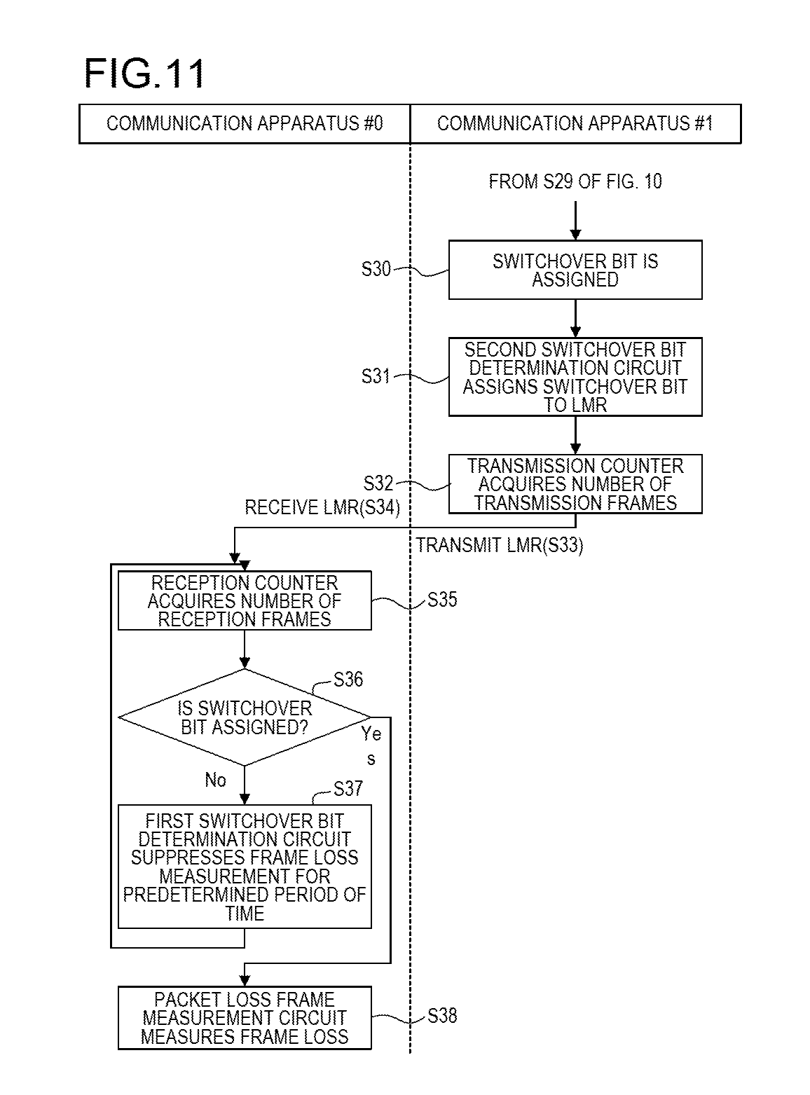

Next, descriptions will be made on a frame loss measurement adjusting process in a case where switchover of the IF card has occurred in the communication system 100 as an example of the embodiment in line with the flowchart illustrated in FIGS. 10 and 11 (Operation S21 to S38).

In addition, FIG. 10 illustrates processings of Operations S21 to S29, and FIG. 11 illustrates processings of Operations S30 to S38.

The processings of Operations S21 to S25 and S34 to S38 illustrated in FIGS. 10 and 11 are executed by the IF card #01 of the standby system provided in the communication apparatus #0 illustrated in FIG. 3. The processing of Operations S26 to S33 illustrated in FIGS. 10 and 11 are executed by the IF card #10 provided in the communication apparatus #1 illustrated in FIG. 4.

The packet loss frame generation circuit 111 of the communication apparatus #0 generates the LMM (Operation S21 in FIG. 10).

The switchover bit assignment circuit 112 of the communication apparatus #0 determines whether a switchover bit assignment instruction (interrupt) due to the switchover of the IF card 11 occurs. In the example illustrated in FIG. 10, it is assumed that the switchover bit assignment instruction has issued, and the switchover bit assignment circuit 112 receives the switchover bit assignment instruction from, for example, the control card 13 (Operation S22 in FIG. 10).

When the switchover bit assignment instruction is received, the switchover bit assignment circuit 112 assigns the switchover bit to the LMM generated by the packet loss frame generation circuit 111 (Operation S23 in FIG. 10).

The transmission counter 113 of the communication apparatus #0 increments the transmission count value (the number of transmission frames) according to the transmission of the LMM to acquire the number of transmission frames (Operation S24 in FIG. 10).

The communication apparatus #0 transmits the LMM to the communication apparatus #1 (Operation S25 in FIG. 10).

The communication apparatus #1 receives the LMM from the communication apparatus #0 (Operation S26 in FIG. 10).

The reception counter 114 of the communication apparatus #1 increments the reception count value (the number of reception frames) according to the reception of the LMM to acquire the number of reception frames (Operation S27 in FIG. 10).

The packet loss frame determination circuit 117 of the communication apparatus #1 determines whether the data received from the communication apparatus #0 is the LMM (Operation S28 in FIG. 10). In the example illustrated in FIG. 10, it is assumed that the received data are the LMM.

The packet loss frame format update circuit 118 of the communication apparatus #1 updates the LMM received from the communication apparatus #0 with the LMR (Operation S29 in FIG. 10).

The second switchover bit determination circuit 119 of the communication apparatus #1 determines whether a switchover bit is assigned to the LMM received from the communication apparatus #0. In the example illustrated in FIG. 11, the second switchover bit determination circuit 119 determines that the switchover bit is assigned to the received LMM (Operation S30 in FIG. 11) and assigns the switchover bit to the LMR updated by the packet loss frame format update circuit 118 (Operation S31 in FIG. 11).

The transmission counter 113 of the communication apparatus #1 increments the transmission count value (the number of transmission frames) according to the transmission (reply) of the LMR to acquire the number of transmission frames (Operation S32 in FIG. 11).

The communication apparatus #1 transmits (replies) the LMR to the communication apparatus #0 (Operation S33 in FIG. 11).

The communication apparatus #0 receives the LMR from the communication apparatus #1 (Operation S34 in FIG. 11).

The reception counter 114 of the communication apparatus #0 increments the reception count value (the number of reception frames) according to the reception of the LMR to acquire the number of reception frames (Operation S35 in FIG. 11).

The first switchover bit determination circuit 115 of the communication apparatus #0 determines whether the switchover bit is assigned to the LMM which is transmitted to the communication apparatus #1, and the switchover bit is assigned to the LMR received from the communication apparatus #1 (Operation S36 in FIG. 11). In the example illustrated in FIG. 11, the switchover bit is assigned to the transmitted LMM at Operation S23 in FIG. 10, and thus, the first switchover bit determination circuit 115 determines that the switchover bit is assigned to the LMM which is transmitted to the communication apparatus #1.

In a case where the switchover bit is not assigned to the received LMR (see the “NO” route of Operation S36 in FIG. 11), the first switchover bit determination circuit 115 suppresses the frame loss measurement by the packet loss frame measurement circuit 116 for a predetermined period of time (Operation S37 in FIG. 11). Then, the frame loss measurement adjusting process returns to Operation S34 in FIG. 11, and the communication apparatus #0 waits for reception of the next LMR. There may be a case where the LMM to which the switchover bit is not assigned is transmitted to the communication apparatus #1 by the IF card #00 of the active system before the switchover of the IF card 11, and the LMM is updated with the LMR, to which the switchover bit is not assigned, by the communication apparatus #1 and transmitted to the IF card #01 of the standby system. The first switchover bit determination circuit 115 of the IF card #01 which receives the LMR, to which the switchover bit is not assigned, executes the processing of Operation S37.

In a case where the switchover bit is assigned to the received LMR (see the “YES” route of Operation S36 in FIG. 11), the packet loss frame measurement circuit 116 measures the frame loss occurring between the communication apparatuses #0 and #1 (Operation S38 in FIG. 11). Specifically, the packet loss frame measurement circuit 116 determines whether the number of transmission frames acquired at Operation S24 in FIG. 10 coincides with the number of reception frames acquired at Operation S35 in FIG. 11. With this, the packet loss frame measurement circuit 116 measures the frame loss occurring between the communication apparatuses #0 and #1. Then, the frame loss measurement adjusting process is ended.

### A-3 Operation Timing

Descriptions will be made on transmission and reception timing of the packet loss frame in the communication system 100, which is configured as described above, as an example of the embodiment with reference to timing charts illustrated in FIGS. 12A to 15B.

FIG. 12A is a timing chart illustrating transmission and reception timing of a packet loss frame in an active system IF card included in the communication apparatus 1 of the transmission side as an example of the embodiment. FIG. 12B is a timing chart illustrating transmission and reception timing of the packet loss frame in a standby system IF card 11 included in the communication apparatus 1 of the transmission side.

FIGS. 12A and 12B are timing charts illustrating timings common to transmission timing of the LMM and reception timing of the LMR by the communication apparatus #0.

As illustrated in FIG. 12A, the IF card #00 of the active system periodically transmits the LMM to the communication apparatus #1 and receives the LMR from the communication apparatus #1, for example, at each of timings s0 to s4. The packet loss frame measurement circuit 116 of the IF card #00 of the active system continues performing the frame loss measurement, for example, in a period of time including the respective timings s0 to s4.

As illustrated in FIG. 12B, the IF card #01 of the standby system periodically transmits the LMM and receives the LMR from the communication apparatus #1, for example, at each of the timings t0 to t4. The transmission of the LMM and the reception of the LMR by the IF card #01 of the standby system are performed in order to increment the transmission counter 113 and the reception counter 114 in a hot standby state. For that reason, the transmitted LMM may be discarded before being sent out to the network 4 (see FIG. 3) after the transmission counter 113 is incremented, and the received LMR may be discarded after the reception counter 114 is incremented. The packet loss frame measurement circuit 116 of the IF card #01 of the standby system is in a state of stopping the frame loss measurement, for example, in a period of time including each of the timings t0 to t4.

Although the reception timings s0 to s4 of the LMR are later than the transmission timings s0 to s4 of the LMM, respectively, by a time required for a reciprocation transmission between the communication apparatuses #0 and #1, the reception timings and the transmission timings are represented by the same timings, respectively, in FIG. 12A for brevity. Similarly, although the reception timings t0 to t4 of the LMR are later than the transmission timings t0 to t4 of the LMM, respectively, by a time required for a reciprocation transmission between the communication apparatuses #0 and #1, the reception timings and the transmission timings are represented by the same timings, respectively, in FIG. 12B for brevity.

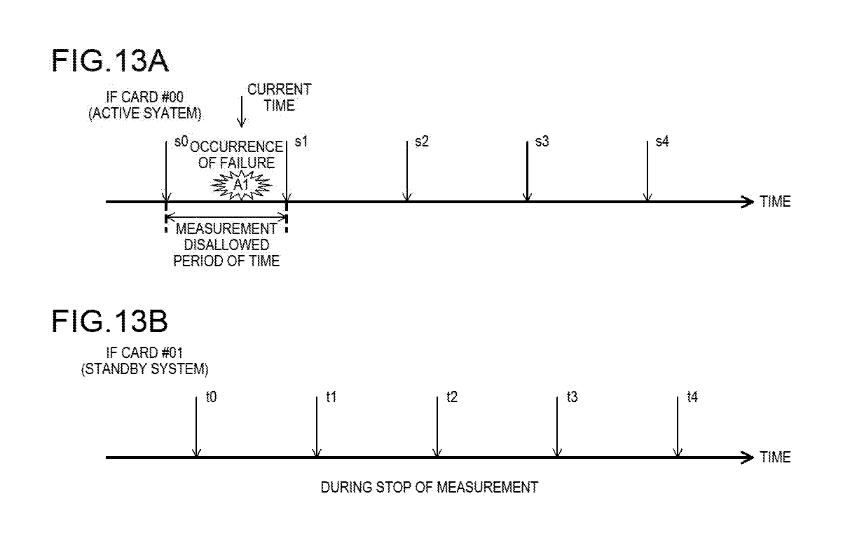

FIG. 13A is a timing chart illustrating transmission and reception timing of a packet loss frame in the active system IF card 11 included in the communication apparatus of the transmission side when a failure occurs as an example of the embodiment, and FIG. 13B is a timing chart illustrating transmission and reception timing of the packet loss frame in the standby system IF card 11 included in the communication apparatus of the transmission side when the failure occurs.

FIGS. 13A and 13B are timing charts illustrating timings common to transmission timing of the LMM and reception timing of the LMR by the communication apparatus #0.

In the example illustrated in FIG. 13A, it is assumed that a failure has occurred on a path to which the IF card #00 or the IF card #00 is connected at the current timing which belongs within timings s0 to s1 (see the reference numeral A1 of FIG. 13A). Due to an occurrence of a fault, the frame loss measurement becomes unable in a period of time including the timings s0 to s1 in the communication apparatus #0.

As illustrated in FIG. 13B, the packet loss frame measurement circuit 116 of the IF card #01 of the standby system is in a state of stopping the frame loss measurement, for example, in a period of time including each of the timings t0 to t4 similar to the example illustrated in FIG. 12B.

Although, the reception timings s0 to s4 of the LMR are later than the transmission timings s0 to s4 of the LMM, respectively, by a time required for a reciprocation transmission between the communication apparatuses #0 and #1, the reception timings and the transmission timings are represented by the same timings, respectively, in FIG. 13A for brevity. Similarly, the reception timings t0 to t4 of the LMR are later than the transmission timings t0 to t4 of the LMM, respectively, by a time required for a reciprocation transmission between the communication apparatuses #0 and #1, the reception timings and the transmission timings are represented by the same timings, respectively, in FIG. 13B for brevity.

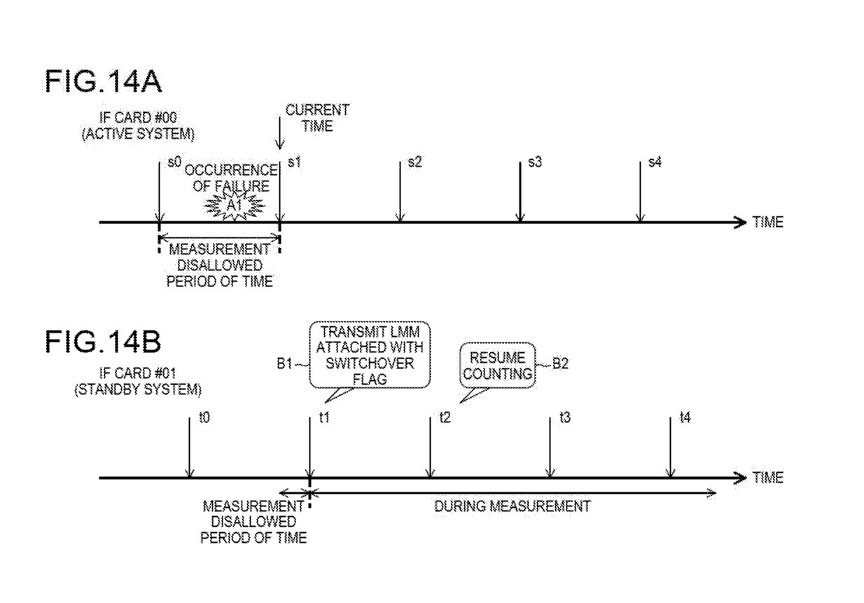

FIG. 14A is a timing chart illustrating transmission timing of a packet loss frame in the active system IF 11 card included in the communication apparatus 1 as an example of the embodiment after switchover of the IF card 11. FIG. 14B is a timing chart illustrating reception timing of the packet loss frame in the standby system IF 11 included in the communication apparatus after switchover of the IF card 11.

FIGS. 14A and 14B are timing charts illustrating timings common to transmission timing of the LMM by the communication apparatus #0.

In the example illustrated in FIG. 14A, it is assumed that a failure has occurred in the IF card #00 of the active system (see the reference numeral A1 in FIG. 14A), and switchover of the frame loss measurement function from the IF card #00 to the IF card #01 has occurred. Furthermore, it is assumed that the current timing is timing s1.

As illustrated in FIG. 14B, a period of time until the timing t1 is reached becomes a period of time during which the frame loss measurement becomes unable in the IF card #01 of the standby system. The IF card #01 transmits the LMM, to which the switchover bit is assigned by the switchover bit assignment circuit 112, to the communication apparatus #1 at the timing t1 (see the reference numeral B1 in FIG. 14B). The transmission counter 113 of the IF card #01 restarts counting of the transmission count value at timing t2 (see the reference numeral B2 in FIG. 14B). With this, the packet loss frame measurement circuit 116 of the IF card #01 executes the frame loss measurement at the respective timings after the timing t1.

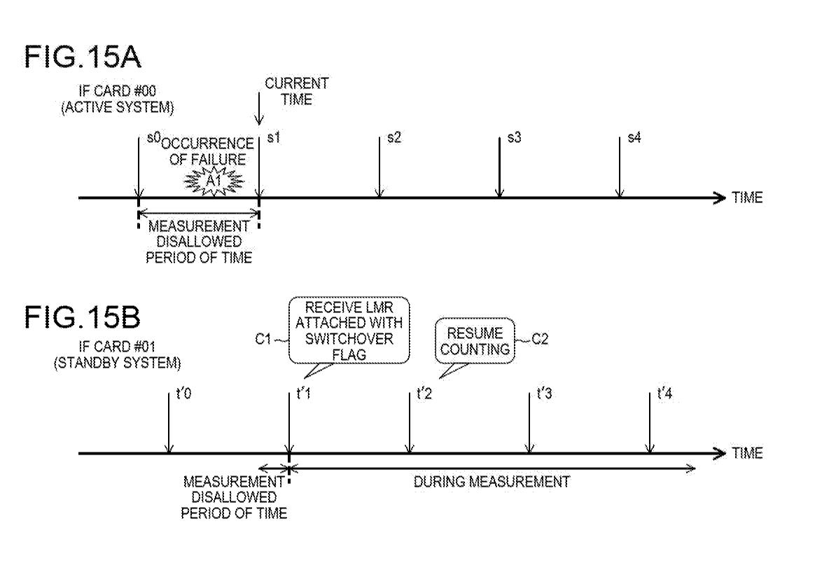

FIG. 15A is a timing chart illustrating reception timing of a packet loss frame in the active system IF card 11 included in the communication apparatus 1 of the transmission side as an example of the embodiment after switchover of an IF card. FIG. 15B is a timing chart illustrating reception timing of a packet loss frame in the standby system IF card 11 included in the communication apparatus 1 of the transmission side.

FIGS. 15A and 15B are timing charts illustrating timings common to reception timing of the LMR by the communication apparatus #0.

Here, reception timings t′0 to t′4 of the LMR illustrated in FIG. 15B are later than respective transmission timings t0 to t4 of the LMM illustrated in FIG. 14B, respectively, by a time required for a reciprocation transmission between the communication apparatuses #0 and #1. Although, the reception timings s0 to s4 of the LMR illustrated in FIG. 15A are later than the transmission timings s0 to s4 of the LMM illustrated in FIG. 14A, respectively, by a time required for a reciprocation transmission between the communication apparatuses #0 and #1, the reception timings and the transmission timings are represented by the same timings, respectively, in FIG. 14A and FIG. 15A for brevity.

In the example illustrated in FIG. 15A, it is assumed that a failure has occurred in the IF card #00 of the active system in the period of time from the timing s0 to the timing s1 (see the reference numeral A1 in FIG. 15A), and switchover of the frame loss measurement function from the IF card #00 to the IF card #01 has occurred, similar to the example illustrated in FIG. 14A. Furthermore, it is assumed that the current timing is the timing s1.

As illustrated in FIG. 15B, a period of time until the timing t′1 is reached becomes a period of time during which the frame loss measurement becomes unable in the IF card #01 of the standby system. The IF card #01 receives the LMR, to which the switchover bit is assigned, from the communication apparatus #1 at the timing t′1 (see the reference numeral C1 in FIG. 15B). The transmission counter 114 of the IF card #01 restarts counting of the transmission count value at the timing t′2 (see the reference numeral C2 in FIG. 15B). With this, the packet loss frame measurement circuit 116 of the IF card #01 executes the frame loss measurement at respective timings after the timing t′1.

That is, the first switchover bit determination circuit 115 suppresses the frame loss measurement for a period of time from the transmission timing t1 (see the reference numeral B1 in FIG. 14B) of the LMM, to the switchover bit is assigned, to the reception timing t′1 of the LMR to the switchover bit is assigned (see the reference numeral C1 in FIG. 15B). The frame loss measurement adjusting process returns to Operation S34 in FIG. 11, and the communication apparatus #0 waits for reception of the next LMR.

### A-4 Effects

The switchover bit assignment circuit 112 assigns the switchover bit, which indicates the occurrence of switchover from to the standby system IF card, to the measurement frame to be transmitted to other communication apparatus 1. The first switchover bit determination circuit 115 excludes frames, which are transferred during a period of time from transmission of the switchover bit to reception of the switchover bit from other communication apparatus 11, from the data loss measurement targets by the packet loss frame measurement circuit 116.

With this, even when redundant switchover occurs, it is possible to eliminate inconsistency in the frame loss measurement and accurately conduct the frame loss measurement. Specifically, as illustrated in the above-mentioned Equation (1) and Equation (2), the frame loss measurement is performed with a calculation by a relative comparison of the transmission count values and the reception count values in continuous two generations. Here, the frame loss measurement is stopped once immediately after the switchover of the IF card 11, and thus, the frame loss measurement after the stopping may be normally performed.

Furthermore, retained information of the count value may not be synchronized by software between the IF card #00 of the active system and the IF card #01 of the standby system, and a load of the CPU or software may be reduced so that the performance or reliability of the communication system 100 may be improved. In a case where synchronization of the counter values is implemented by software, synchronization of thousands to tens of thousands of measurement values by the IF card 11 may be required to be implemented within a regulated period of time (e.g., 50 milliseonds), and thus, a high cost is required.

Furthermore, the measurement immediately after the switchover is stopped, and thus, a value indicating abnormality is not notified to the user. Therefore, it is possible to reduce complication in monitoring of the communication system 100 by the user.

In a case where the switchover bit is assigned to the LMM to be transmitted to other communication apparatus 1, the switchover bit assignment circuit 112 initializes the count value of the transmission counter 113 provided in the same IF card 11. In a case where the switchover bit is assigned to the LMR received from another communication apparatus 1, the first switchover bit determination circuit 115 initializes the count value of the reception counter 114 provided in the same IF card 11.

With this, it is possible to more accurately conduct the frame loss measurement.

The packet loss frame measurement circuit 118 updates the format of the LMM received from another communication apparatus 1 with the format of the LMR to be transmitted to other communication apparatus 1.

With this, the frame loss measurement may be executed using the packet loss frame of which format is compliant with the conventional frame format between two communication apparatuses #0 and #1, and thus, manufacturing costs of the communication apparatus 1 may be reduced.

### B Others

The technique disclosed herein is not limited to the embodiment described above and may be embodied in a variety of other forms within a range departing from a gist of the embodiment of the present disclosure. Respective configuration and respective processing may be omitted and selected as necessary, and may also be appropriately combined.

In an example of the embodiment described above, although the switchover of the frame loss measurement function is performed from the IF card #00 of the active system to the IF card #01 of the standby system provided in the communication apparatus #0 (see FIG. 3), the switchover is not limited thereto. For example, in a case where the switchover of the frame loss measurement function is performed from the IF card #00 of the active system to the IF card #01 of the standby system, a fault occurring on a path to which the IF card #00 or the IF card #01 is eliminated. After the elimination of the fault, even in a case where the switchover of the frame loss measurement function from the IF card #01 to the IF card #00 occurs, the communication system 100 may perform the frame loss measurement adjusting process such as an example of the embodiment described above. Also, it is possible to achieve the same effect as that of the example of the embodiment described above.

In the example of the embodiment, although the frame loss measurement adjusting process is executed in a case where the switchover bit assignment instruction (interrupt) occurs, the frame loss measurement adjusting process is not limited thereto. For example, the user may stop an operation of the IF card #00 of the active system for maintenance or preventive replacement before occurrence of a fault. In a case where the operation of the IF card #00 is made to stop, the user may input the switchover bit assignment instruction (interrupt) to the communication apparatus 1 through, for example, the control terminal 3 (see FIG. 2). Also, in this case, the communication system 100 may execute a frame loss measurement such as the frame loss measurement of the example of the embodiment. Also, it is possible to achieve the same effect as that of the example of the embodiment described above.

It is possible to examine whether the communication system 100, the communication apparatus 1, or the communication method in the example of the embodiment is utilized by capturing a packet loss frame transmitted and received between two communication apparatuses 1 and analyzing the packet loss frame.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first communication apparatus capable of performing a switchover of a communication path from an active system to a standby system, and configured to include a first hardware processor configured to:
count a number of transmissions and a number of receptions of a measurement frame assigned between frames transferred on the communication path when a communication of the active system is performed, by an active system counter,
count the number of transmissions and the number of receptions of the measurement frame when a communication of the standby system is performed, by a standby system counter,
measure a data loss based on a count value of the active system counter or the standby system counter, and
assign switchover indication information for indicating an occurrence of the switchover from the active system to the standby system, to the measurement frame to be transmitted; and
a second communication apparatus capable of performing a switchover of a communication path from an active system to a standby system, and configured to include a second hardware processor configured to:
assign reception indication information for indicating a reception of the switchover indication information, to a measurement frame to be transmitted to the first communication apparatus according to reception, from the first communication apparatus, of the measurement frame to which the switchover indication information is assigned,
wherein the first hardware processor measures the data loss by excluding frames which are transferred during a period of time from a transmission of the switchover indication information to a reception of the reception indication information, from a measurement target.

2. The communication system according to claim 1,
wherein each of the active system counter and the standby system counter includes:
a transmission counter configured to count the number of transmissions of the measurement frame to be transmitted to the second communication apparatus, and
a reception counter configured to count the number of receptions of the measurement frame received from the second communication apparatus, and
wherein the first hardware processor measures the data loss based on a count value of the transmission counter and a count value of the reception counter.

3. The communication system according to claim 2,
wherein the first hardware processor:
initializes the count value of the transmission counter when the switchover indication information is assigned to the measurement frame to be transmitted to the second communication apparatus, and
initializes the count value of the reception counter when the reception indication information is assigned to the measurement frame received from the second communication apparatus.

4. The communication system according to claim 1,
wherein the second hardware processor is further configured to update a format of the measurement frame to be transmitted to the first communication apparatus according to a format of the measurement frame received from the first communication apparatus, and
the second hardware processor assigns the reception indication information to the measurement frame of the updated format in a case where the switchover indication information is assigned to the measurement frame received from the first transmission apparatus.

5. A communication apparatus capable of performing a switchover of a communication path from an active system to a standby system, the communication apparatus comprising:
a hardware processor configured to:
count a number of transmissions and a number of receptions of a measurement frame assigned between frames transferred on the communication path when a communication of the active system is performed, by an active system counter,
count a number of transmissions and a number of receptions of the measurement frame when a communication of the standby system is performed,
assign switchover indication information for indicating an occurrence of the switchover from the active system to the standby system, to the measurement frame to be transmitted to other communication apparatus, and
measure a data loss based on a count value of the active system counter or the standby system counter, by excluding frames which are transferred during a period of time from a transmission of the switchover indication information to a reception of the reception indication information transmitted from the other communication apparatus which has received the switchover indication information, from a measurement target.

6. The communication apparatus according to claim 5,
wherein each of the active system counter and the standby system counter includes:
a transmission counter configured to count the number of transmissions of the measurement frame to be transmitted to the other communication apparatus, and
a reception counter configured to count the number of receptions of the measurement frame received from the other communication apparatus, and
wherein the first hardware processor measures the data loss based on a count value of the transmission counter and a count value of the reception counter.

7. The communication apparatus according to claim 6,
wherein the first hardware processor:
initializes the count value of the transmission counter when the switchover indication information is assigned to the measurement frame to be transmitted to the other communication apparatus, and
initializes the count value of the reception counter when the reception indication information is assigned to the measurement frame received from the other communication apparatus.

8. A communication method in a communication system provided with a first communication apparatus and a second communication apparatus each capable of performing a switchover of a communication path from an active system to a standby system, the communication method comprising:
counting a number of transmissions and a number of receptions of a measurement frame assigned between frames transferred on the communication path when a communication of the active system is performed, by an active system counter of the first communication apparatus;
counting the number of transmissions and the number of receptions of the measurement frame when a communication of the standby system is performed, by a standby system counter of the first communication apparatus;
assigning switchover indication information for indicating an occurrence of the switchover from the active system to the standby system, to the measurement frame to be transmitted to the second communication apparatus, by the first communication apparatus;
assigning reception indication information for indicating a reception of the switchover indication information, to a measurement frame to be transmitted to the first communication apparatus according to reception, from the first communication apparatus, of the measurement frame to which the switchover indication information is assigned, by the second communication apparatus; and
measuring a data loss based on a count value of the active system counter or the standby system counter, by excluding frames which are transferred during a period of time from a transmission of the switchover indication information to a reception of the reception indication information transmitted from the second communication apparatus which has received the switchover indication information, from a measurement target.

9. The communication method according to claim 8, further comprising:
counting the number of transmissions of the measurement frame to be transmitted to the second communication apparatus, by a transmission counter included in each of the active system counter and the standby system counter in the first communication apparatus;
counting the number of receptions of the measurement frame received from the second communication apparatus, by a reception counter included in each of the active system counter and the standby system counter in the first communication apparatus; and
measuring the data loss based on a count value of the transmission counter and a count value of the reception counter of the first communication apparatus.

10. The communication method according to claim 9, further comprising:
initializing the count value of the transmission counter, by the first communication apparatus, when the switchover indication information is assigned to the measurement frame to be transmitted to the second communication apparatus; and
initializing the count value of the reception counter, by the first communication apparatus, when the reception indication information is assigned to the measurement frame received from the second communication apparatus.

11. The communication method according to claim 8, further comprising:
updating a format of the measurement frame to be transmitted to the first communication apparatus according to a format of the measurement frame received from the first communication apparatus, by the second communication apparatus; and
assigning the reception indication information to the measurement frame of the updated format in a case where the switchover indication information is assigned to the measurement frame received from the first transmission apparatus, by the second communication apparatus.
